(19) United States
(12) Patent Application Publication
(10) Pub. No.: US 2017/0028705 A1
(43) Pub. Date: Feb. 2, 2017

(54) Adjustable position magnetic alignment registration assembly for single or multi station manual screen printing press head attachments

(71) Applicant: Nathanael Joseph DeHart, Meridian, ID (US)

(72) Inventor: Nathanael Joseph DeHart, Meridian, ID (US)

(21) Appl. No.: 15/081,855

(22) Filed: Mar. 26, 2016

Related U.S. Application Data
(60) Provisional application No. 62/199,926, filed on Jul. 31, 2015.

(51) Int. Cl. B41F 15/34

(52) U.S. Cl. CPC B41F 15/34

(57) ABSTRACT

A variable position magnetic alignment registration assembly for use with single or multiple station screen printing presses. The assembly comprises a screen, a frame designed to support weight and placement of screen during pre-press alignment registration requirements and during press printing actions, and magnets to secure screen firmly in place once pre-press registration requirements are complete and during the printing process of one or two color numbers or logos.

### BACKGROUND AND FIELD OF INVENTION

Screen printing is a process for conduction printing by means of transferring ink which is passed through mesh screen fixed within a frame housing, filled with printing ink. A blade or squeegee is moved across the screen to fill the open mesh apertures with ink, and a reverse stroke then causes the screen to touch the substrate momentarily along a line of contact. This causes the ink to wet the substrate and be pulled out of the mesh apertures as the screen springs back after the blade has passed. The most common type of screen printing press is a rotary type, which has individual heads holding the frame of each screen used during the press process.

### OBJECTIVE AND SUMMARY OF INVENTION

As a benefit for screen printers who frequently print numbers, during the pre-press and press process, the invention will guarantee the screen will be secure on the magnetic frame while in contact with the ink transfer to the substrate yet allow for quick and frequent changing of positions in registration.

It is the intent of the present invention to provide a very fast and efficient registration or alignment of screen for printing production, especially numbers, when the positions vary per job requirements.

In order to achieve the forementioned objective/benefit, a screen printing assembly according to the present invention is provided comprising:
a) A screen
b) A frame for supporting screen and for attaching to press head
c) A backplate capable of easily guiding bi-directional horizontal movement of screen
d) Magnetics on frame
e) Registration marks on screen and backplate

At time of using this screen printing invention, the screen is placed onto the support frame, and against the registration backplate. Magnets hold the screen in place to support frame while the backplate aids in alignment for registration and movement of screen. Once registration is complete, production begins and the support frame is lifted up and down over the printed substrate on the press carousel platen.

### BRIEF DESCRIPTIONS OF DRAWING

FIG. 1 is a cross section view of support frame structure and screen. The screen (e) uses metal strips (f) to hold its position to support frame (c) cross bars (a), while resting up against the back alignment stop bracket (b) and highlights the magnetic force/bond for the screen to the support frame. Support frame attaches to printing press using bar (d).

FIG. 2 shows the general overview of the support frame structure and screen together. The support frame consists of support bars (c) and rear support bar (d) that attaches to printing press head clamps. Screen slides against support frame's back alignment stop bracket (b) and support cross bar (a) allowing for screen (e) to move bi-directionally as needed. Upon registration, magnets hold screen to support frame in position firmly between screen metal strips (f) and support frame.

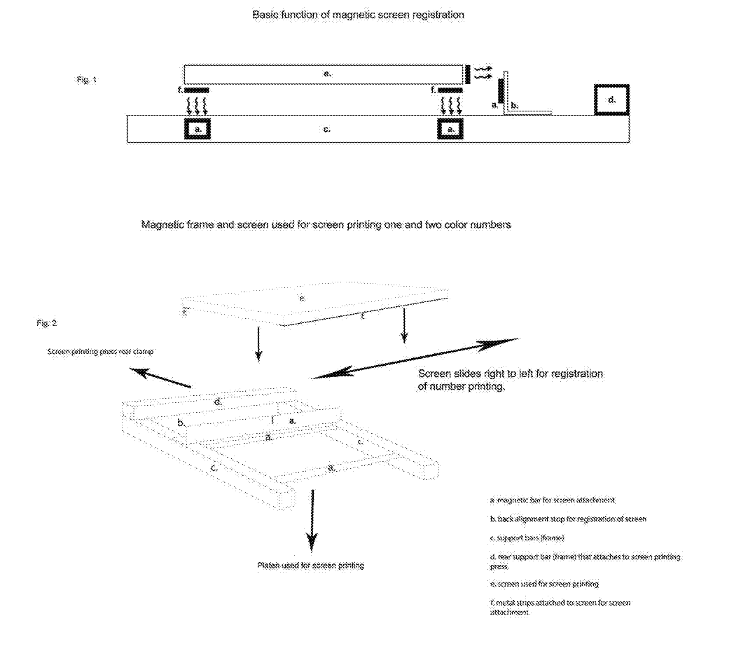

What is claimed is:

1. A screen printing assembly for securing placement of screen using magnets during screen registration process and during contact with imprinted substrate comprising:
a frame for support of screen;
a means for positional placement of screen;
a magnetic means for holding screen in place;

2. The assembly of claim 1 wherein the frame for support of screen includes back plate to guide bi-directional horizontal movement and display registration marks, and a rear support bar for attachment to printing press head.

3. The assembly of claim 1 wherein the frame for support of screen includes attached magnets to hold screen in place during the printing ink to substrate contact process.
